(19) United States
(12) Patent Application Publication
(10) Pub. No.: US 2021/0093916 A1
(43) Pub. Date: Apr. 1, 2021

(54) SYSTEM AND APPARATUS FOR PERFORMANCE MONITORING

(71) Applicant: SCORCHED ICE INC., Okotoks (CA)

(72) Inventors: John LOWE, Okotoks (CA); Bruce WRIGHT, Okotoks (CA); Adile ABBADI-MACINTOSH, Calgary, Alberta (CA)

(73) Assignee: SCORCHED ICE INC., Okotoks (CA)

(21) Appl. No.: 16/621,862

(22) PCT Filed: Jun. 12, 2018
(86) PCT No.: PCT/CA2018/000116

§ 371 Date: Dec. 12, 2019

Related U.S. Application Data
(60) Provisional application No. 62/518,010, filed on Jun. 12, 2017.

(51) Int. Cl. A63B 24/00; A63C 1/30; A42B 3/04

(52) U.S. Cl. CPC A63B 24/0062; A63C 1/30; A63B 2244/18; A63B 2220/40; A63B 2220/72; A42B 3/0406

(57) ABSTRACT

There is disclosed a novel system and method for performance monitoring of athletes. In an embodiment, the system comprises a plurality of sensor modules mounted on different locations of an athlete, wherein at least one of the plurality of sensor modules is a master sensor module configured to interconnect with all other sensor modules to collect performance data for transmission to a computer system configured to collect the performance data. In an embodiment, a sensor module is housed in a cavity of a blade holder in at least one skate of a pair of skates worn by a hockey player.

### FIELD OF THE INVENTION

The present invention relates generally to a system and apparatus for performance monitoring, and more particularly to monitoring the performance of athletes.

### BACKGROUND

In recent years, as sensor technology has improved and decreased in cost, monitoring the performance of athletes using sensors worn on various parts of the body has become more commonplace. While sensors worn by athletes in confined spaces with limited motion (such as cardio training or strength training on exercise machines or free weights) are now widely available, and can be wired or connected wirelessly to monitoring equipment positioned nearby, sensor technologies for team sports played on large playing surfaces are still technically challenging. In particular, performance monitoring of athletes in high speed, high impact team sports, for example hockey or football, still have room for significant improvement in order to collect and analyze data at a similar level to data that can be collected for other types of activities in more confined spaces.

What is needed is a performance monitoring solution that overcomes some of these challenges.

### SUMMARY

The present disclosure relates to a system and apparatus for performance monitoring, particularly in high speed, high impact team sports played on large surface areas, for example, hockey played on ice rinks, basketball and other games played on hard surface courts, or football, soccer, rugby, and other games played on grass fields, artificial turf, or the like.

In an aspect, the system and apparatus comprises at least one master sensor module worn by an athlete with one or more additional sensors worn on other locations of the athlete's body.

In one example embodiment, a sensor module is integrated into a piece of equipment worn by an athlete, such as a helmet or a pair of shoes or skates. In another embodiment, a sensor module is integrated into athletic equipment that is handled by an athlete, such as a hockey or lacrosse stick.

In another example embodiment in the context of hockey, the sensors may be housed in the cavity of a supporting frame located below the athlete's foot, but just above the blade of a skate. In other example embodiments, the sensors may be integrated into footwear, such as cleats or court shoes. The sensors may be integrated into a circuit board having a processor and a memory, and may include one or more accelerometers, one or more gyroscopes, one or more magnetometers, a barometer, and various sensors including, for example, one or more temperature sensors, one or more ranging sensors including a Bluetooth RSSI (Received Signal Strength Indication) between devices, or an UWB (Ultra-Wideband) ranging device, or even one or more optical ranging devices. The circuit board may be powered by a power source, such as a rechargeable battery that can be replaced or charged in situ within the cavity by connecting a charger at an externally accessible charging port, or in some example embodiments the power source may be charged wirelessly.

In another example embodiment, the circuit board may further include a wireless transceiver module for short range communications. For example, short-range communications including Bluetooth™, Wi-Fi™, or UWB, may be used to connect sensors in an embodiment including a pair of skates, and may further enable connection and coordination with other sensors integrated into other equipment worn by the athlete, for example, such as a helmet, body padding, a waist belt, a chest belt, or a plurality of sensors integrated into various locations on a bodysuit. Sensors integrated into equipment handled by the athlete, for example a hockey or lacrosse stick, may also be in communication and coordination with sensors worn on the athlete's body. In another embodiment, in addition to motion sensors, biometric sensors that provide measurements of an athlete's physical condition, such as stress level, hydration, heartbeat, oxygen levels, etc., may be integrated to provide data that is correlated to the athlete's motion, position, and acceleration data.

In another embodiment in the hockey context, a sensor module housed in a cavity of a pair of skates comprises a master module, and further includes one or more wireless transceivers for longer range, high speed communications, such as Wi-Fi™, UWB or LTE™. This longer range, high speed communications may be used by a remote data collection server in order to coordinate and transfer data collected from multiple sensors worn by an athlete. For example, in some embodiments, the remote data collection server may be a desktop computer located within an arena, or a laptop computer or tablet used by coaching staff. As described above, in other embodiments, the sensor module may be integrated into other types of athletic footwear, as required by the context of the sport being played. For example, sensor modules may be integrated into the soles of court shoes or spiked shoes, or otherwise affixed in a manner to assist with the sensing function particular to the sport in question. As described above, sensor modules may also be integrated into sports equipment that is handled by the athlete, such as a hockey stick or lacrosse stick. Further, as described above, these motion and acceleration sensor modules may be further integrated and coordinated with biometric sensors to provide data relating to the athlete's physical condition that correlates to position, motion, and/or acceleration data.

In another example embodiment, a longer-range wireless transceiver may also receive communications from a remote computer in order to relay communications from coaching staff to the athlete. In some embodiments, these communications may be delivered to the athlete, for example, via earphones or via a small monitor integrated into a helmet. Alternatively, communications may take the form of visual depictions—either static or dynamic live or streaming video—projected onto a lens or other headwear affixed to the athlete. This communication system may thus be used for coaching, for example, during training sessions, or for providing live feedback and guidance during a sporting event or performance. In another example embodiment, communications may take the form of haptic feedback delivered through equipment that the athlete is handling, such as a hockey stick or lacrosse stick.

In another example embodiment, the wireless transceiver may also transmit and receive communications between two or more players via the remote server. The wireless transceiver may also transmit and receive communications directly between players. This may allow the communication system to be used to enable multi-party communications between players and coaching staff, during a training session, game, or other interaction.

In some example embodiments, the sensors of the sensor module housed in a cavity of a shoe or skate are protected by a shock absorbing inner housing in order to withstand external shocks, for example, the shock of stopping a hockey puck launched by a slap shot, or blocking a tackle during a football play.

In another embodiment, the sensors or the sensor module housed in a skate or shoe cavity are removable, such that any performance data stored on the sensor or sensor module that did not successfully transmit to a remote data collection server may still be downloaded and captured. This direct data collection from the sensor or sensor module may also be used to download more bandwidth-intensive data, such as video, which may require too much bandwidth when multiple players are attempting to transmit performance data simultaneously or when bandwidth is unavailable due to technical limitations in the particular setting the athletes finds themselves. It will be appreciated, however, that if multiple data collection servers are active at the same time, it would be possible to independently record video data from multiple players in real-time.

It is to be understood that the invention is not limited in its application to the details of construction and to the arrangements of the components set forth in the following description or the examples provided therein, or illustrated in the drawings. Therefore, it will be appreciated that a number of variants and modifications can be made without departing from the scope of the invention as described herein. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present invention will be better understood and objects of the invention will become apparent when consideration is given to the following detailed description thereof. Such description makes reference to the annexed drawings, wherein:

FIG. 1 depicts a schematic diagram of an example sensor module in accordance with an embodiment.

FIG. 2 depicts a schematic diagram of an athlete wearing a plurality of exemplary sensor modules, one at the waist, and one at each foot.

FIG. 3 depicts an example schematic diagram of an athlete's anthropometric model in accordance with an illustrative embodiment.

FIG. 4 depicts an example schematic diagram of an athlete with a plurality of sensor positions that may be tracked by the system.

FIG. 5 depicts an example schematic diagram of a hockey player wearing a plurality of sensors that may be tracked by the system.

FIG. 6 depicts an example frame for a skate having a cavity configured to receive a sensor module, where the sensor module may be further protected by means of a protective housing.

FIG. 7 depicts a closer view of an example inner protective housing that may be formed to fit within the sensor module cavity.

FIGS. 8 to 11 depict schematic diagrams of an athlete with a plurality of interconnected sensors in various example configurations.

FIG. 12 depicts a schematic diagram of an athlete's sensors in communication with a plurality of transceivers in fixed locations around a playing surface.

FIG. 13 depicts a schematic diagram of a plurality of athletes' sensors communicating simultaneously with a plurality of transceivers in fixed locations around a playing surface.

FIG. 14 depicts a schematic diagram of a data collection arrangement wherein a plurality of sensors on an athlete transmit data to one or more computing devices near the playing surface, which in turn may upload the data to a cloud processing environment for storage and processing.

FIG. 15 depicts a schematic block diagram of an example helmet audio-video system including at least one helmet-mounted camera and at least one microphone configured to capture video and audio.

FIG. 16 depicts a schematic block diagram of an example computer device configured to interact with sensors and sensor modules, and associated communications networks, devices, software and firmware that may be configured to provide a platform for enabling one or more embodiments.

### DETAILED DESCRIPTION

As noted above, the present disclosure relates to a system and apparatus for performance monitoring, particularly in high speed, high impact team sports played on large surface areas, such as hockey played on ice rinks, basketball and other games played on hard surface courts, or football, soccer, rugby and other games played on grass or artificial turf fields, or the like. Various example embodiments will now be described with reference to the drawings.

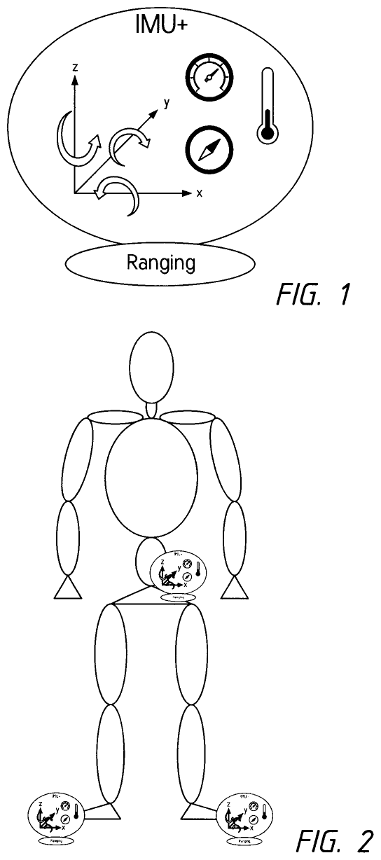

FIG. 1 depicts an inertia measurement unit (IMU), which may be a sensor module that includes one or more accelerometers, one or more gyroscopes, and one or more magnetometers. The IMU sensor module may further include a barometer, and a temperature sensor.

As depicted in FIG. 2, a plurality of IMU sensor modules may be worn by an athlete, for example at each of the athlete's feet, and at the athlete's waist. In one embodiment, when worn by a hockey player, the IMU sensor modules may be housed in the player's skates, and more particularly in the cavity of a supporting frame located below the athlete's foot, but just above the blade of the skate. This example embodiment in the context of hockey will be discussed in further detail below with reference to FIGS. 5, 6, and 7.

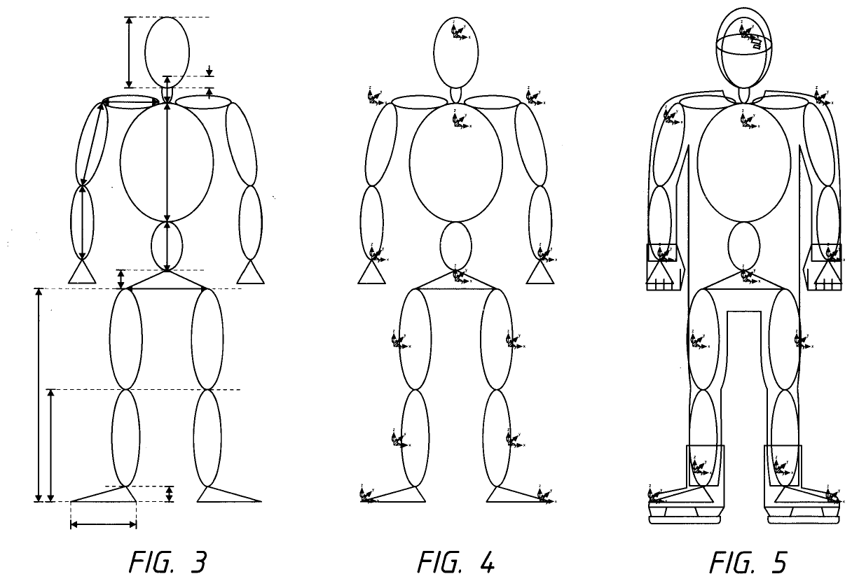

FIG. 3 depicts an example schematic diagram of an athlete's anthropometric model with a 19 element full-body diagram. Each element has multi-axis constrained rotations relative to other elements. The anthropometric model may be used to measure and record an athlete's specific limb dimensions, such that the athlete's body measurements can be input into a player system configured to interpret data being collected for that particular athlete.

FIG. 4 depicts a schematic diagram of an athlete with a plurality of IMU sensor module positions that may be tracked by the system. While a plurality of IMU sensor modules may be worn to track the movement of the entire athlete's body, one of the modules may be a designated as a master sensor module, with additional processing capability configured to capture and store data from all of the other IMU sensor modules worn on other parts of the body, that are configured as slave sensor modules.

FIG. 5 depicts a schematic diagram depicting an exemplary system, in this embodiment, a hockey player wearing a plurality of sensor modules that may be tracked by the system. As shown, a plurality of sensor modules may be worn by the athlete on various parts of the body. For example, the sensor modules may be housed in skates, shin guards, pants, gloves, shoulder pads, and/or a helmet. When the plurality of sensor modules are integrated, they comprise part of a player system that is capable of capturing extensive data, as described in more detail further below. It is understood that in the context of other sports, the sensor modules may be integrated into other appropriate footwear, garments or padding or other protective or performance-enhancing equipment specific to the sport being played, for example, football helmets and cleats and shoulder pads in the case of football, or cleats, helmet, shoulder pads, and kidney protectors in the case of lacrosse. In some embodiments, sensor modules may also be integrated into equipment that is handled by the athlete, including, for example, hockey sticks and lacrosse sticks. In another embodiment, in addition to motion sensor modules, biometric sensors that provide measurements of an athlete's physical condition, such as stress, hydration, heartbeat, oxygen levels, etc., may be integrated to provide data that is correlated to the athlete's motion, position, and acceleration data. This biometric data may also be correlated with the anthropometric data described with respect to FIG. 3 above.

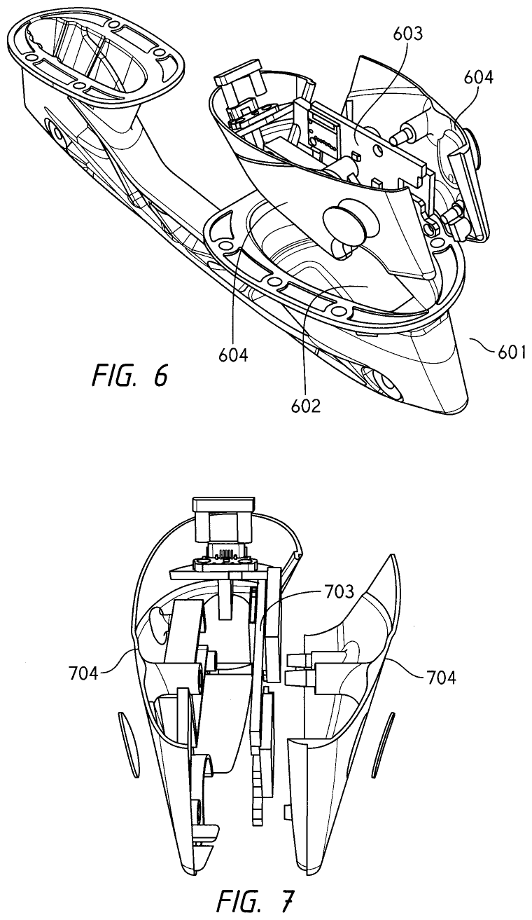

As an illustrative example, FIG. 6 depicts a frame 601 for a skate including a frame cavity 602 configured to receive a sensor module 603, where the sensor module may be further protected by an inner protective housing 604. Frame 601 may be configured to be attached to the bottom surface of a skate boot and also configured to hold the skate blade. FIG. 7 depicts a closer view of an example inner protective housing 704 that may be formed to fit within a frame cavity of a skate and is configured to house a sensor module 703. The circuit boards incorporating the sensor modules depicted in FIGS. 6 and 7 may be powered by a power source, such as a rechargeable battery that can be replaced or charged in situ within the cavity by connecting a charger at an externally accessible charging port. Alternately the power source could be charged wirelessly, for example by using the Qi, PMA, or Airfuel standards. The circuit board may further include a data storage device configured to store data collected by the player system.

In another example embodiment, the sensors, the circuit board, and data storage devices housed in the cavity are protected by an inner housing in order to withstand external shocks, such as the shock of stopping a hockey puck launched by a slap shot, or the impact of a blocked tackle in a high-impact sport such as football.

In another embodiment, the data storage device and/or the sensor module is configured to be removed so that any performance data stored on the data storage device that did not successfully transmit to a remote data collection server may still be downloaded and captured directly from the removable storage device. The removable storage device may be, for example, a microSD™ solid state memory card capable of storing gigabytes of data. This direct data collection from the sensor module may also be used to download more bandwidth-intensive data, such as video, which may require too much bandwidth when multiple players are attempting to transmit performance data simultaneously, or when bandwidth is unavailable due to technical limitations in the particular setting that the athletes find themselves. It will be appreciated, however, that if multiple data collection servers are active at the same time, it would be possible to independently record video data from multiple players simultaneously in real-time.

In another embodiment, the circuit boards depicted in FIGS. 6 and 7 may further include a wireless transceiver module for short range communications. For example, in one embodiment in the hockey context, short range communications including Bluetooth™ may be used to connect sensors in each of a pair of skates, and may further enable connection to other sensors integrated into other equipment worn by the athlete, such as a helmet, a waist belt, a chest belt, or a plurality of sensors integrated into various locations on a bodysuit. In a further embodiment, the sensors may be sewn directly into the bodysuit using conductive thread or otherwise affixed such that minimal additional wires are needed. In another example embodiment, connected sensors that are integrated into equipment that is handled by the athlete, for example, hockey sticks or lacrosse sticks, may also be in communication with other sensors. Further, as described above, these motion and acceleration sensors may be further integrated and coordinated with biometric sensors to provide data relating to the athlete's physical condition that correlates to position, motion, and/or acceleration data collected by other sensors.

By way of example, when the sensor modules are capturing data at a data sampling rate of 100 Hz, a total internal data rate is estimated to be 2300 to 4000 bytes/sec per module, or more.

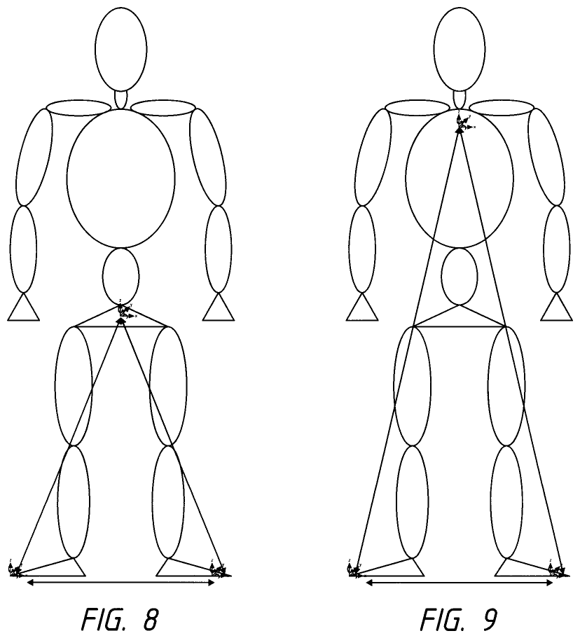

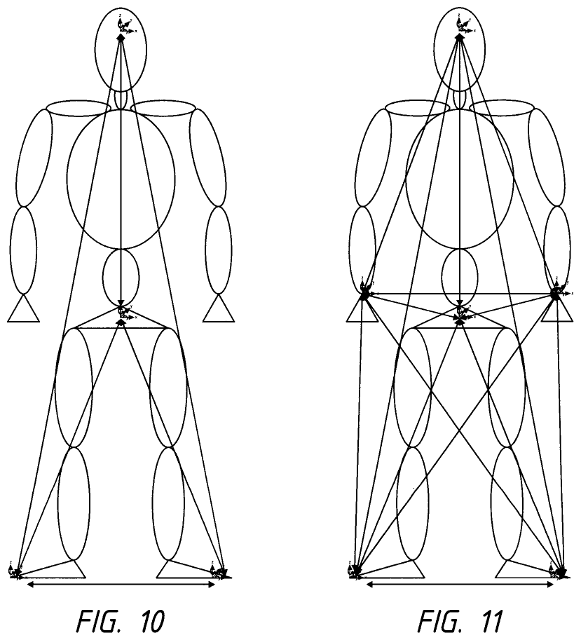

FIGS. 8 to 11 depict schematic diagrams of an athlete with a plurality of interconnected sensors in various different configurations comprising player systems. In a 3-sensor system, for example, a sensor module may be placed on each foot, and either the pelvis of a player (FIG. 8) or the player's sternum (FIG. 9). More complex player systems, as depicted in FIG. 10 and FIG. 11, may include 4 to 6 sensor modules each of which communicate with a master sensor module, and with each other. When the plurality of sensors and sensor modules are integrated together in a player system, then the player system is capable of capturing extensive performance data for various types of skill evaluations. In the context of hockey, these skill evaluations may include, but are not limited to, stance, blade edges, balance, forward stride, stopping, backwards skating, turns, transitions, and crossovers. Various types of motion may also be measured, including, for example, acceleration, stride rate, stride length, edge use, etc. In other sports contexts, the player system may be configured to measure data for skill evaluations more specific to those sports. For example, in the context of football, the player system may collect data for skill evaluations related to vertical leap, broad jump, shuttle speed, sprint speed, 3-cone drill speed, etc.

In an example embodiment in the hockey context, the player system may also be configured to measure various parameters, including absolute skate orientation, relative skate-to-skate orientation, relative skate-to-skate position, body orientation, relative body-to-skate orientation, and relative body-to-skate position. As will be appreciated, certain sensor modules will experience higher dynamic characteristics, such as sensor modules attached to a player's feet. Other modules, such as the sensor module at the player's hips, will have a relatively slower dynamic characteristic. This relative dynamism of the sensor modules may depend on the context of the sport in which the athlete is engaged. The player system may include algorithms to combine the data from the modules to give relative orientations, and positioning of an athlete's to body and limbs. Depending on whether the type of data being collected is more specific to an individual player, or more team-oriented, the number of sensors or sensor modules worn by the athletes may be varied.

In an example embodiment, the player system further includes one or more wireless transceivers configured for longer-range, high-speed communications, such as Wi-Fi™, UWB, or LTE™. These longer-range, high-speed communications may be used to transfer data collected from multiple sensors or sensor modules worn by an athlete to a remote data collection server. For example, the remote data collection server may be a desktop computer located within an arena or stadium, a laptop computer or tablet used by coaching staff, or a remote server providing cloud data storage services.

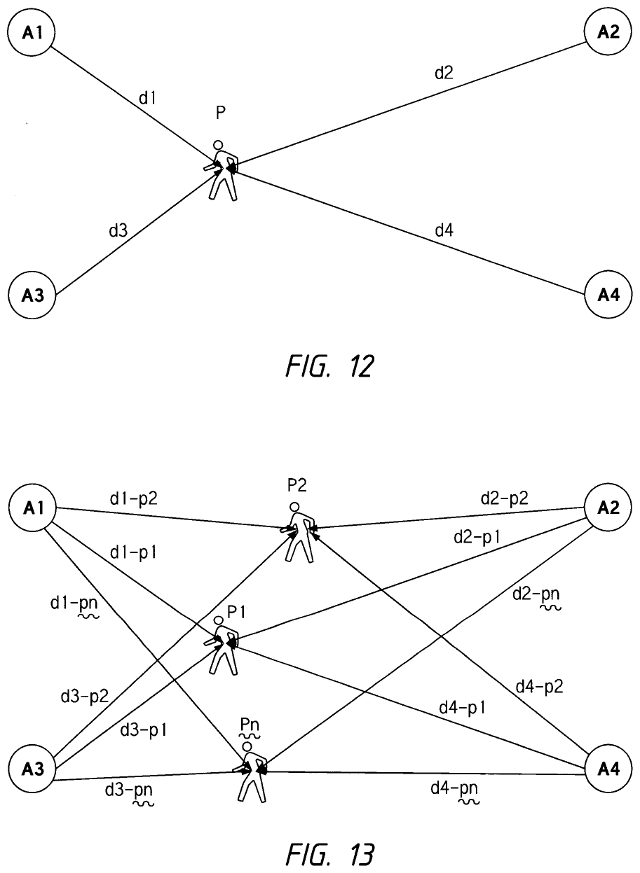

FIG. 12 depicts a schematic diagram of an athlete's sensors communicating with a positioning infrastructure comprising a plurality of transceivers A1-A4 in fixed locations around a playing surface which may be used to determine the absolute location of a player based on the player's distances d1, d2, d3, d4 from each of the transceivers A1-A4. In the context of hockey, the plurality of transceivers may be positioned at various corners of an arena, such that each of the transceivers can communicate with the athlete's sensors to provide an absolute location of a player within the hockey rink. The plurality of transceivers may also act as data collection points for collecting data transmitted by the player system. In certain embodiments, cameras and/or microphones may be installed in addition to transceivers at multiple fixed locations around the playing surface or space in order to capture audio and visual information correlated to the data collected from the player's individual sensors and modules. In some embodiments, this audio and visual information may be processed together with the data collected by the transceivers so as to provide three-dimensional audio and visual context to the collected player location data. In this case, coaches or spectators may have access to virtual recreations of player perspectives on the playing surface during gameplay. In some embodiments, this may take the form of virtual or augmented reality display of simultaneous live-streamed player data and audio-visual data via a headset or other hardware device configured to process such data and present it to a hardware user for consumption. In the context of virtual or augmented reality, the display of player data and audio-visual data can be combined with additional hardware elements which can convey vibratory or other haptic feedback in varying intensity so as to enhance the hardware user's experience. For example, the system can be configured so as to impart to the hardware user a physical sensation consistent with an impact force experienced by a player whose sensor modules are transmitting data. In some embodiments, this feedback may be transmitted through equipment that is handled by the athletes, for example, through feedback sensors integrated in a hockey stick or lacrosse stick. Further, as described above, these motion and acceleration sensor modules may be further integrated and coordinated with biometric sensors to provide data relating to the athlete's physical condition that correlates to position, motion, and/or acceleration data.

In another embodiment, the longer-range wireless transceiver may also receive communications from a remote computer in order to relay communications from coaching staff to the athlete. These communications may be delivered to the athlete, for example, via earphones or via a small monitor integrated into a helmet or other lens surface (for example, glasses, sunglasses, goggles, or other eyewear). This exemplary communication system may thus be used for real-time coaching, for example, during training sessions, competitive play, or other performances.

As depicted in FIG. 13, multiple players' sensors and sensor modules may communicate simultaneously with a plurality of transceivers in fixed locations around a playing surface may provide coaching staff with real-time collection of team data.

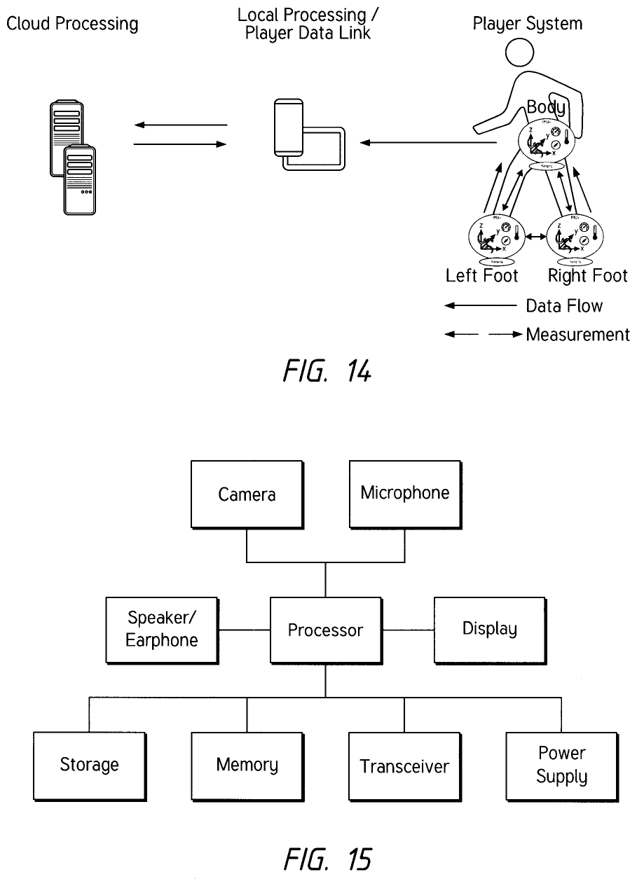

FIG. 14 depicts a schematic diagram of data collected from a plurality of sensors on an athlete being transmitted to one or more computing devices locally near the playing surface. This locally transmitted data may then be uploaded to a cloud processing environment for processing, collection, and storage. Thus, large volumes of data captured during a training session or a game may be uploaded to a cloud storage environment for further processing and analysis.

The positioning data collected for all players on the playing surface at the same time may allow coaching staff to collect data on how effectively the players are implementing practiced team formations or other configurations designed to increase the likelihood of effective game play. The positioning data can be used, for example, to alert the coaching staff as to whether a player is consistently out of expected or desired position, or situations in which a player is fatigued to the point of impacting player performance such that player rotation, replacement, or substitution is appropriate. This positioning data may be further correlated with biometric data collected from additional biometric sensors located on the player, such as stress level, pulse or heartbeat, hydration, oxygen levels, etc.

In another embodiment, a remote server may be configured to allow a wireless transceiver to transmit and receive communications between two or more players. In other embodiments, a wireless transceiver may also be configured to transmit and receive communications directly between players. This configuration may allow a communication system to be used to enable multi-party communications between players and coaching staff, for example during a training session. In some example embodiments, players may receive communication from the coaching staff via earphones or integrated video screen in a helmet or lens surface (in case of glasses, sunglasses, googles, or the like).

FIG. 15 depicts an example schematic block diagram of a helmet-based audio-video system including a helmet-mounted camera and a microphone for capturing video and audio from a player's perspective. The helmet-based audio-video system may further include a speaker or earphone to allow a player to receive audio, and a monitor or display which may be mounted on a helmet visor for receiving video. An onboard processor with access to memory, storage, a transceiver for wireless communication, and a portable power supply may also be included.

In an example embodiment in the context of hockey, the helmet audio-video system described in FIG. 15 may be configured to be used in combination with integrated sensors in a player's sensor bodysuit, and further in combination with a sensor system installed in, or on, the player's skates to allow real-time capture of the player's position, including the positions of the player's limbs.

In another embodiment in the hockey context, a sensor and transmitter may be placed within a puck to determine the location of the puck on the ice and relative to the players. By using the sensors to identify a player's position and body/limb orientation, the positioning system identifies where a player is located on the ice, and the helmet-mounted cameras may capture the player's perspective. In this example, as the puck moves around the ice and is tracked by the positioning system, the positioning system may determine which player is closest to the action at any given time. This may allow the spectator to shift perspective to whichever player is presently controlling the puck. In other sports contexts, similarly integrated sensor and positioning systems may allow a spectator to shift perspectives to whichever player is controlling the ball, for example, a football or basketball. In those examples, the football or basketball may also have integrated sensor modules.

The sensor system in combination with the positioning system is thus configured to create a real-time, virtual environment where a spectator can see and experience the game from the perspective of any one of the players presently active on the playing surface. This perspective will allow a spectator to virtually experience a game at the playing surface level as if they were playing. In some examples, the spectator may also replay captured data in slow-motion, if desired, in order to clearly see captured video from the players' perspectives on the playing surface.

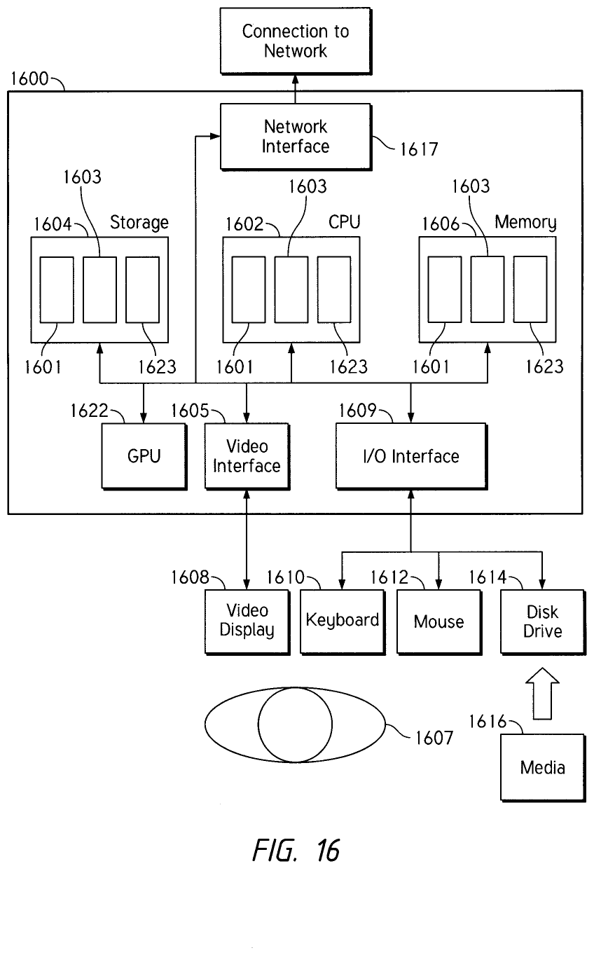

FIG. 16 depicts a suitably configured computer device 1600, and associated communications networks, devices, software and firmware configured to provide a platform for enabling one or more embodiments, as described above. Computer device 1600 may be embodied in any number of different form factors ranging from a rack mounted or desktop computer, laptop, tablet, phablet or smartphone. Computer device 1600 may include a central processing unit (“CPU”) 1602 connected to a storage unit 1604 and to a random access memory 1606. The CPU 1602 may process an operating system 1601, application program 1603, and data 1623. The operating system 1601, application program 1603, and data 1623 may be stored in storage unit 1604 and loaded into memory 1606, as may be required. Computer device 1600 may further include a graphics processing unit (GPU) 1622 that is operatively connected to CPU 1602 and to memory 1606 to offload intensive image processing calculations from CPU 1602 and run these calculations in parallel with CPU 1602. An operator 1607 may interact with the computer device 1600 using a video display 1608 connected by a video interface 1605, and various input/output devices such as a keyboard 1610, pointer 1612, and a removable storage device 1614 connected by an I/O interface 1609 and configured to receive storage media 1616. Pointer 1612 may be configured to control movement of a cursor or pointer icon in the video display 1608, and to operate various graphical user interface (GUI) controls appearing in the video display 1608. The computer device 1600 may form part of a network via a network interface 1617, allowing the computer device 1600 to communicate with other suitably configured data processing systems or circuits.

While various illustrative embodiments have been described above by way of example, it will be appreciated that various changes and modifications may be made without departing from the scope of the invention, which is defined by the following claims.

What is claimed is:

1. A system for performance monitoring of athletes, comprising:
a plurality of sensor modules mounted on different locations of an athlete;
wherein, at least one of the plurality of sensor modules comprises a master sensor module configured to interconnect all of the sensor modules in the plurality of sensor modules for transmission to a computer system configured to collect and process performance data derived from the plurality of sensor modules.

2. The system of claim 1, wherein the athlete is a hockey player, and at least one sensor module is housed in or on at least one skate of a pair of skates worn by the hockey player.

3. The system of claim 2, wherein the at least one sensor module is housed in or on a cavity of a blade holder located above a blade of the at least one skate but below a skate boot of the at least one skate.

4. The system of claim 2, wherein the at least one sensor module comprises a circuit board having a processor and a memory, and the sensor module further includes one or more accelerometers, one or more gyroscopes, one or more magnetometers, or one or more range sensors.

5. The system of claim 4, wherein the at least one sensor module integrated into a circuit board further includes at least one of a barometer or a temperature sensor.

6. The system of claim 4, wherein the circuit board is powered by an onboard power source.

7. The system of claim 6, wherein the onboard power source is a rechargeable battery.

8. The system of claim 6, wherein the onboard power source is configured to be recharged by external or wireless charging.

9. The system of claim 1, wherein the performance data comprises one or more of: acceleration, stride rate, stride length, and edge use.

10. The system of claim 9, wherein the performance data is processed to determine one or more player skill evaluation including one or more of: stance, blade edges, balance, forward stride, stopping, backwards skating, turns, transitions, and crossovers.

11. The system of claim 1, wherein the plurality of sensor modules includes at least one sensor module configured to provide biometric data.

12. The system of claim 1, wherein at least one of the plurality of sensors is housed in a helmet configured to be worn by a player, wherein the helmet contains a camera and microphone.

13. A method for collecting and processing a player's performance data comprising:
interconnecting a plurality of sensor modules worn on different locations throughout a body of the player through a master sensor module;
transmitting the player's performance data from the master sensor module to a processing system;
processing the performance data to provide skill evaluation data of the player.

14. The method of claim 13, wherein the player's performance data comprises one or more of: acceleration, stride rate, stride length, and edge use.

15. The method of claim 13, wherein the player's skill evaluation data comprises one or more of: stance, blade edges, balance, forward stride, stopping, backwards skating, turns, transitions, and crossovers.

16. The method of claim 13, wherein the plurality of sensor modules includes at least one biometric sensor.

17. A skate comprising:
a first sensor module configured to track acceleration, movement, and/or range of an individual wearing the skate, wherein the first sensor module is further configured to coordinate with at least a second sensor module that is integrated into non-skate-based equipment or clothing worn by the individual.

18. The skate of claim 17, wherein the first sensor module is further configured to be integrated into a frame of the skate.

19. The skate of claim 18, wherein the frame of the skate is located between a blade of the skate and a bottom surface of a boot of the skate.

20. The skate of claim 17, wherein the first sensor module is configured to be a master sensor module, wherein the master sensor module is configured to integrate and transmit data from the second sensor module to a processor.
